(19) United States
(12) Patent Application Publication
(10) Pub. No.: US 2025/0050717 A1
(43) Pub. Date: Feb. 13, 2025

(54) car cover limiting structure

(71) Applicant: ZHEJIANG SURPASS AUTO PARTS CO.,LTD., Wenzhou City, Zhejiang Province (CN)

(72) Inventors: Shiqi Zheng, Wenzhou City (CN); Dongdong Wang, Wenzhou City (CN); Yien Wang, Wenzhou City (CN); Yi Lin, Wenzhou City (CN); Lei Lin, Wenzhou City (CN)

(21) Appl. No.: 18/398,600

(22) Filed: Dec. 28, 2023

(30) Foreign Application Priority Data
Aug. 10, 2023 (CN) 202322153451.6

(51) Int. Cl. B60J 7/14

(52) U.S. Cl. CPC B60J 7/141

(57) ABSTRACT

The present invention discloses a car cover limiting structure, it includes a guide rail, a side rail and a first side rail limit positioning block, the first side rail limit positioning block is connected to the side rail, the first side rail limit positioning block includes a barrier plate, the barrier plate is used to resist and limit with the guide rail. By setting the car cover limiting structure, the present invention enables the car cover does not to move from side to side in use, so as to facilitate the opening and closing of the car cover.

### TECHNICAL FIELD

This invention is relevant to automotive spare parts, especially a car cover limiting structure

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using it to cover the goods inside the hopper.

Most of the existing car cover is first connected to the rail and the cargo hopper, and then the car cover is flat on the guide rail to realize the waterproof effect, this connection makes the car cover move from side to side in the process of using, as long as the car cover moves from side to side, it is not only not able to play a good waterproof effect, but also inconvenient to open and close the car cover.

### ABOUT THE INVENTION

To overcome the existing technical deficiencies, the present invention provides a car cover limiting structure, which prevents the car cover from moving from side to side by limiting the car cover with the limiting structure.

In order to solve the above problems of the existing technology, the technical solution adopted in the invention is as follows:

A car cover limiting structure includes a guide rail, a side rail, and a first side rail limit positioning block.

The first side rail limit positioning block is connected to the side rail, the first side rail limit positioning block includes a barrier plate, the barrier plate is used to resist and limit with the guide rail.

Further, the side rail is provided with a side rail groove, the first side rail limit positioning block further includes a first insertion plate, the first insertion plate is connected to the side rail groove, the first insertion plate is capable of moving forward and backward along the side rail groove after it is extended into the side rail groove, the first side rail limit positioning block is of an integral structure, the first side rail limit positioning block is provided with a first positioning hole, by providing a first positioning hole, when the first side rail limit positioning block is moved to an appropriate position, a screw passes through the first positioning hole to connect the first side rail limit positioning block with the side rail.

A car cover limiting structure includes a guide rail, a side rail and a second side rail limit positioning block.

The second side rail limit positioning block is connected to the guide rail, the second side rail limit positioning block includes a transverse stop plate, the transverse stop plate is used to resist and limit with the side rail.

Further, the second side rail limit positioning block is of an integral structure, the second side rail limit positioning block is provided with a second positioning hole, by providing the second positioning hole, when the position of the second side rail limit positioning block is determined, a screw passes through the second positioning hole to connect the second side rail limit positioning block and the guide rail.

Further, the guide rail includes a guide rail tongue and a guide rail groove, the side rail includes a side rail blocking line, the second side rail limit positioning block further includes a second insertion plate, the second insertion plate is connected to the guide rail groove, the side rail blocking line is the inner side of the side rail in contact with the second side rail limit positioning block, the second side rail limit positioning block further includes a bracket plate, the bracket plate is provided between the second insertion plate and the transverse stop plate, The bracket plate is provided on a lower side of the guide rail tongue, the bracket plate is used to support the guide rail tongue.

A car cover limit structure includes a guide rail, a side rail and a limiting positioning system.

The limit positioning system is connected to the side rail, the limit positioning system includes a mounting rod and a groove limit positioning block, the mounting bar is connected to the side rail, the groove limit positioning block includes a clamping plate, the clamping plate is used for limiting the guide rail.

By setting up the limit positioning system, not only can the locking assembly be connected, but also can play a limiting role for the car cover, preventing the car cover from moving from side to side.

Further, the limit positioning system is of an integral structure, the limit positioning system can be of an integral structure or a split structure, both ends of the mounting bar are inserted with groove limit positioning blocks, the mounting bar is provided with a mounting groove, the mounting groove is used for connecting the locking assembly, the groove limit positioning blocks are provided at both ends of the mounting bar and utilizing the guide rails at both ends for limiting to prevent the car cover from moving from side to side, the guide rail is provided with a guide rail tongue.

Further, the side rail is provided with a side rail clamping groove, the groove limit positioning block further includes an insertion head and a third insertion plate, the third insertion plate extends into the side rail clamping groove, the insertion head snap-fits with the mounting bar, the clamping plate snap-fits with the guide rail tongues, by setting the third insertion plate and utilizing the snap fit of the third insertion plate with the side rail, the groove limit positioning block is connected to the side rail, followed by connecting the groove limit positioning block to the mounting bar by the insertion head, so as to make the limit positioning system form an integral piece, the groove limit positioning block is provided with a third positioning hole, by setting the third positioning hole, when the limit positioning block is moved to an appropriate position, a screw is utilized to pass through the third positioning hole to connect the first limit positioning block and the side rail.

A car cover limit positioning structure includes a guide rail, a car cover and a plate blocking block.

The guide rail is connected to the car body.

Further, the plate barrier block is connected to the car cover, the guide rail is used for restricting the plate barrier block, the car cover is a rigid structure, the structure of the plate blocking block is simple and easy to install, it can be bonded to the car cover by glue or by screws, the car cover consists of a frame and a plate body, the frame includes a side rail, the plate barrier block is connected to either the plate body or the side rail.

The beneficial effect of the present invention are:

The present invention by setting the car cover limiting structure, the car cover does not move from side to side when it is in use, so as to facilitate the opening and closing of the car cover.

2. The present invention discloses a variety of car cover limiting structures, which can be connected with the side rails, the guide rails, or the car cover, different models can be chosen for the corresponding car cover limiting structure, with a wide range of applications.

### DESCRIPTION OF DRAWINGS

FIG. 1 is a structure schematic diagram of Embodiment 1,

FIG. 2 is a partially enlarged view of part A of FIG. 1,

FIG. 3 is a structure schematic diagram of embodiment 2,

FIG. 4 is a partially enlarged view of part B in FIG. 3,

FIG. 5 is a structure schematic diagram of embodiment 3,

FIG. 6 is a partially enlarged view of part C in FIG. 5,

FIG. 7 is a structure schematic diagram of embodiment 4,

FIG. 8 is a partially enlarged view of part D in FIG. 7.

Figures: 1—Guide rail, 101—Guide rail tongue, 102—Guide rail groove, 2—Side rail, 201—Side rail groove, 202—Side rail blocking line, 3—First side rail limit positioning block, 301—First positioning hole, 302—First insertion plate, 303—Barrier plate, 4—Second side rail limit positioning block, 401—Second positioning hole, 402—Second insertion plate, 403—Bracket plate, 404—Transverse stop plate, 5—Limiting positioning system, 51—Groove limit positioning block, 5101—Third positioning hole, 5102—Clamp plate, 5103—Insertion head, 5104—Third insertion plate, 52—Mounting groove, 6—Plate barrier block, 7—Plate body.

### The Concrete Method to Carry Out

The following instruction further explains the invention's concrete implementation method.

In order to enable a clearer understanding of the objects mentioned above, features and advantages of the present invention, the invention is described in detail below in connecting with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying drawings. It should be understood that the specific embodiments described herein are intended only to illustrate and explain the present invention and not to limit it.

### EMBODIMENT 1

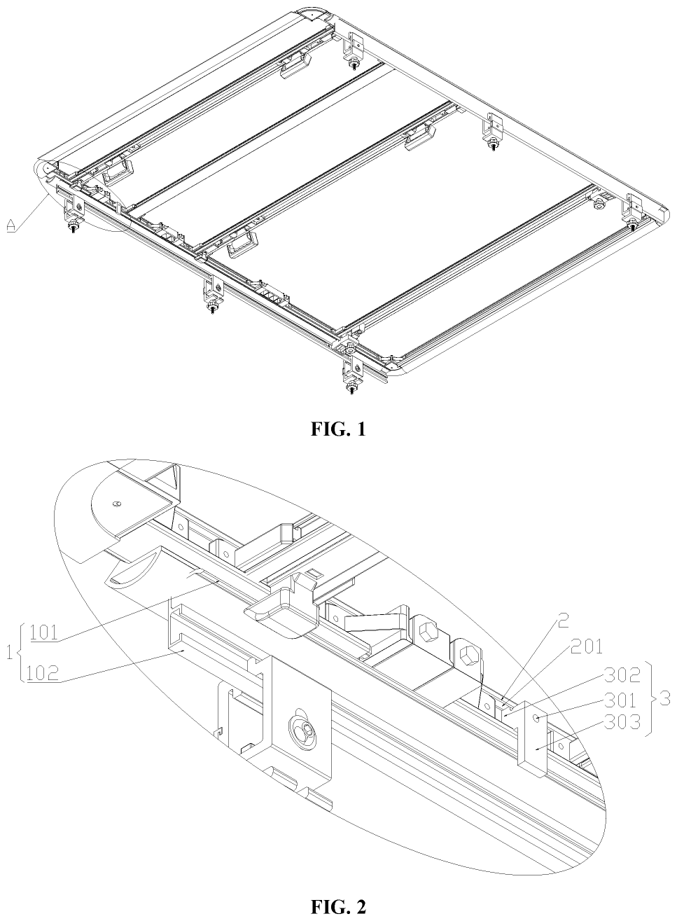

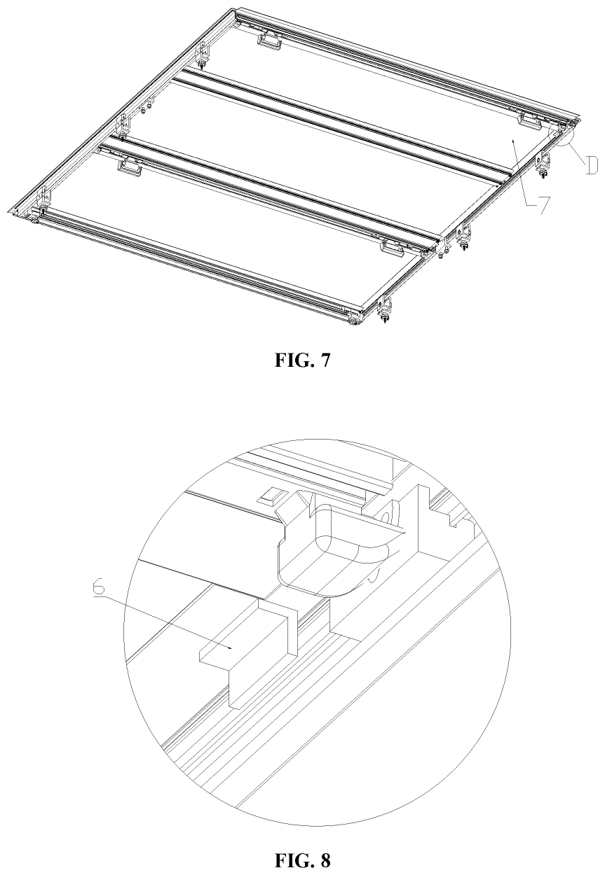

As shown in FIGS. 1, 2 and 7, a car cover limiting structure includes a guide rail 1, a side rail 2 and a first side rail limit positioning block 3.

The first side rail limit positioning block 3 is connected to the side rail 2, the first side rail limit positioning block 3 includes a barrier plate 303, the barrier plate 303 is used to resist and limit with the guide rail 1.

There are two said guide rails 1, the two guide rails 1 are connected to both sides of the cargo hopper, the guide rails 1 includes a guide rail tongue 101 and a guide rail groove 102, the clamping assembly clamps the guide rails 1 to the cargo hopper by the guide rail groove 102, the guide rail tongue 101 is used for limiting the first side rail limit positioning block 3, wherein the car cover consists of a frame and a plate 7, the frame includes a side rail 2, the first side rail limit positioning block 3 is connected to the side rails 2 on both sides, the frame includes a side rail 2, a first side rail limit positioning block 3 is connected to both side rails 2, so that both first side rail limit positioning blocks 3 are resisted and limited to the inner side of the guide rails 1 (the inner side of the guide rails 1 refers to the side where the two guide rails 1 are close to each other), preventing the cover of the car from moving from side to side.

The side rail 2 is provided with a side rail groove 201.

The first side rail limit positioning block 3 further includes a first insertion plate 302, the first insertion plate 302 is connected to the side rail groove 201.

The first insertion plate 302 is able to move back and forth along the side rail groove 201 after it is extended into the side rail groove 201 (back and forth here refers to the front and rear direction of the car body in actual use).

The first side rail limit positioning block 3 is of an integral structure, the first side rail limit positioning block 3 is provided with a first positioning hole 301.

By providing the first positioning hole 301, when the first side rail limit positioning block 3 is moved to an appropriate position, a screw is utilized to pass through the first positioning hole 301 to connect the first side rail limit positioning block 3 and the side rail 2.

### EMBODIMENT 2

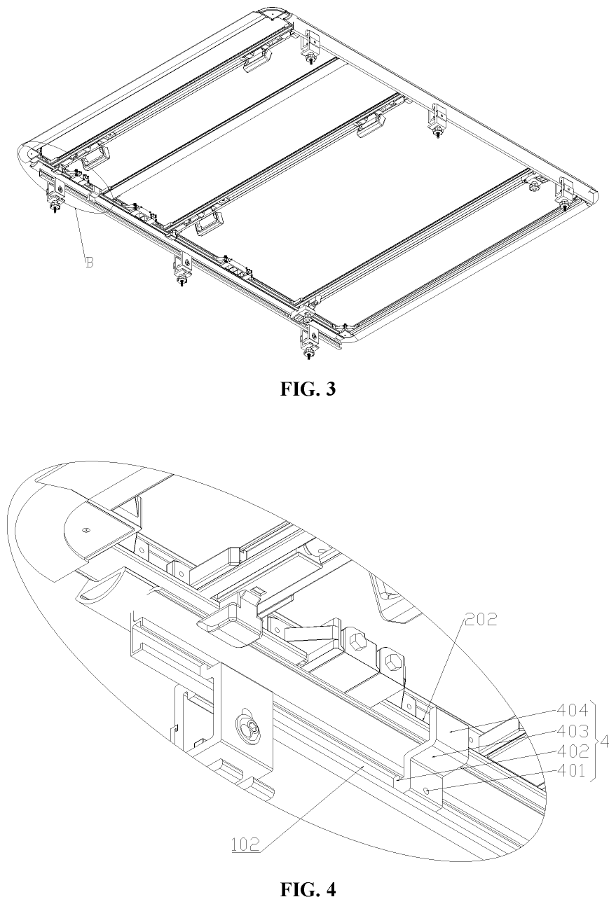

As shown in FIGS. 2, 3, 4 and 7, a car cover limiting structure includes a guide rail 1, a side rail 2 and a second side rail limit positioning block 4.

The second side rail limit positioning block 4 is connected to the guide rail 1, the second side rail limit positioning block 4 includes a transverse stop plate 404, the transverse stop plate 404 is used to resist and limit with the side rail 2.

There are two guide rails 1, the two guide rails 1 are connected to both sides of the cargo hopper, the guide rails 1 includes a guide rail tongue 101 and a guide rail groove 102, the clamping assembly (not shown in the figure) clamps the guide rails 1 to the cargo hopper by the guide rail groove 102, the guide rail groove 102 is connected to the second side rail limit positioning block 4, the car cover consists of a frame and a plate body 7, the frame includes a side rail 2, the second side rail limit positioning block 4 is utilized to limit the car cover, so that the second side rail limit positioning block 4 resists and limits on the inner side of the side rail 2, preventing the car cover from moving from side to side.

The second side rail limit positioning block 4 is of an integral structure, the second side rail limit positioning block 4 is provided with a second positioning hole 401.

By providing the second positioning hole 401, when the position of the second side rail limit positioning block 4 is determined, a screw passes through the second positioning hole 401 to connect the second side rail limit positioning block 4 and the guide rail 1.

The guide rail 1 includes a guide rail tongue 101 and a guide rail groove 102.

The side rail 2 includes a side rail blocking line 202.

The second side rail limit positioning block 4 further includes a second insertion plate 402, the second insertion plate 402 is connected to the guide rail groove 102.

The side rail blocking line 202 refers to the inner side of the side rail 2 in contact with the second side rail limit positioning block 4.

The second side rail limit positioning block 4 further includes a bracket plate 403, the bracket plate 403 is provided between the second insertion plate 402 and the lateral stop plate 404, the bracket plate 403 is provided on the lower side of the guide rail tongue 101, the bracket plate 403 is used to support the guide rail tongue 101.

When in use, the guide rail tongue 101 is overlapped on the bracket plate 403, by providing the bracket plate 403, it can provide a support effect to the guide rail tongue 101 to improve the strength of the guide rail tongue 101.

### EMBODIMENT 3

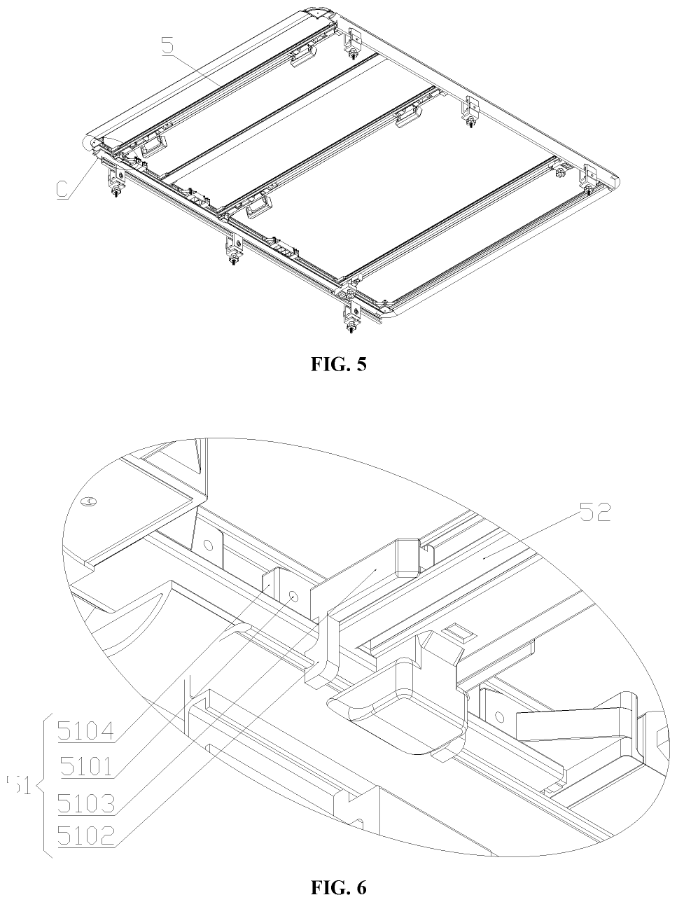

As shown in FIGS. 2, 5-7, a car cover limiting structure includes a guide rail 1, a side rail 2 and a limiting positioning system 5.

The limit positioning system 5 is connected to the side rail 2, the limit positioning system 5 includes a mounting bar and a groove limit positioning block 51, the mounting bar is connected to the side rail 2, the groove limit positioning block 51 includes a clamping plate 5102, the clamping plate 5102 is used for limiting the guide rail 1.

There are two guide rails 1, the two guide rails 1 are connected to both sides of the cargo hopper, the guide rail 1 includes a guide rail tongue 101 and a guide rail groove 102, the clamping assembly clamps the guide rail 1 to the cargo hopper by the guide rail groove 102, the guide rail tongue 101 is used for limiting the groove limiting locating block 51, the car cover consists of a frame and a plate body 7, the frame includes a side rail 2, a groove limit positioning blocks 51 is connected to the side rails 2 on both sides, so that both groove limit positioning blocks 51 resist and limit the rail tongue 101, preventing the car cover from moving from side to side.

By setting the limit positioning system 5, not only can the locking assembly be connected, but also can play a limiting role for the car cover, preventing the car cover from moving from side to side.

The limit positioning system 5 is of an integral structure.

The limit positioning system 5 can be of an integral structure or a split structure.

A groove limit positioning block 51 is inserted at both ends of the mounting rod, the mounting rod is provided with a mounting groove 52, the mounting groove 52 is used to connect the locking assembly.

The groove limit positioning blocks 51 are provided at both ends of the mounting bar to prevent the car cover from moving from side to side by utilizing the guide rails 1 at both ends for limiting.

The guide rail 1 is provided with a guide rail tongue 101.

The side rail 2 is provided with a side rail clamping groove 201.

The groove limit positioning block 51 further includes an insertion head 5103 and a third insertion plate 5104, the third insertion plate 5104 extends into the side rail groove 201, the insertion head 5103 snap-fits with the mounting bar, the clamping plate 5102 snap-fits with the guide rail tongue 101.

By setting the third insertion plate 5104 and utilizing the fitting of the third insertion plate 5104 with the side rail 2, the groove limit positioning block 51 is connected to the side rail 2, followed by connecting the groove limit positioning block 51 to the mounting bar by the insertion head 5103, so as to make the limit positioning system 5 form an integral piece.

The groove limit positioning block 51 is provided with a third positioning hole 5101. By providing the third positioning hole 5101, when the position of the limit positioning system 5 is determined, a screw passes through the third positioning hole 5101 to connect the groove limiting positioning block 51 and the side rails 2.

### EMBODIMENT 4

As shown in FIGS. 2, 7 and 8, a car cover limiting structure includes a guide rail 1, a car cover and a plate blocking block 6.

The guide rail 1 is connected to the car body.

The plate barrier block 6 is connected to the car cover, the guide rail 1 is used for restricting the plate barrier block 6.

The car cover is a rigid structure.

The structure of the plate blocking block 6 is simple and easy to install, it can be bonded to the car cover by glue or by screws.

The car cover consists of a frame and a plate body 7, the frame includes a side rail 2, the plate barrier block 6 is connected to either the plate body 7 or the side rail 2.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A car cover limiting structure, wherein, it includes a guide rail (1), a side rail (2) and a first side rail limit positioning block (3).
The first side rail limit positioning block (3) is connected to the side rail (2), the first side rail limit positioning block (3) includes a barrier plate (303), the barrier plate (303) is used to resist and limit with the guide rail (1).

2. The car cover limiting structure according to claim 1, wherein, the side rail (2) is provided with a side rail groove (201).
The first side rail limit positioning block (3) further includes a first insertion plate (302), the first insertion plate (302) is connected to the side rail groove (201).

3. A car cover limiting structure according to claim 1, wherein, the first side rail limit positioning block (3) is of an integral structure, the first side rail limit positioning block (3) is provided with a first positioning hole (301).

4. A car cover limiting structure, wherein, it includes a guide rail (1), a side rail (2) and a second side rail limit positioning block (4).
The second side rail limit positioning block (4) is connected to the guide rail (1), the second side rail limit positioning block (4) includes a transverse stop plate (404), the transverse stop plate (404) is used to resist and limit with the side rail (2).

5. The car cover limiting structure according to claim 4, wherein, the second side rail limit positioning block (4) is of an integral structure, the second side rail limit positioning block (4) is provided with a second positioning hole (401).

6. The car cover limit structure according to claim 5, wherein, the guide rail (1) includes a guide rail tongue (101) and a guide rail groove (102).
The second side rail limit positioning block (4) further includes a second insertion plate (402), the second insertion plate (402) is connected to the guide rail groove (102).

7. A car cover limiting structure according to claim 6, wherein, the second side rail limit positioning block (4) further includes a bracket plate (403), the bracket plate (403) is provided between the second insertion plate (402) and the transverse stop plate (404), the bracket plate (403) is provided on the lower side of the guide rail tongue (101), the bracket plate (403) is used to support the guide rail tongue (101).

8. A car cover limiting structure, wherein, it includes a guide rail (1), a side rail (2) and a limit positioning system (5).
The limit positioning system (5) is connected to the side rail (2), the limit positioning system (5) includes a mounting bar and a groove limit positioning block (51), the mounting bar is connected to the side rail (2), the groove limit positioning block (51) includes a clamping plate (5102), the clamping plate (5102) is used for limiting the position of the guide rails (1).

9. The car cover limiting structure according to claim 8, wherein, the guide rail (1) is provided with a guide rail tongue (101).
The side rail (2) is provided with a side rail clamping groove (201).
The groove limiting positioning block (51) further includes an insertion head (5103) and a third insertion plate (5104), the third insertion plate (5104) extends into the side rail clamping groove (201), the insertion head (5103) snap-fits with the mounting bar, the clamping plate (5102) snap-fits with the guide rail tongue (101).

10. A car cover limiting structure, wherein, it includes a guide rail (1), a car cover and a plate barrier block (6).
The guide rail (1) is connected to the car body.
The plate barrier block (6) is connected to the car cover, the guide rail (1) is used for restricting the plate barrier block (6).

11. A car cover limiting structure, wherein, the car cover and the plate barrier block (6) or the limit positioning block (3) or the groove limit positioning block (51) are connected to the car body.
The plate barrier block (6) or limit positioning block (3) or groove limit positioning block (51) is connected to the car cover, the edge of the car body is used for limiting the plate barrier block (6).
